(19) United States
(12) Patent Application Publication
(10) Pub. No.: US 2009/0085316 A1
(43) Pub. Date: Apr. 2, 2009

(54) Home and garden cart

(76) Inventor: Victor W. Rodman, Orangevale, CA (US)

Correspondence Address: VICTOR W. RODMAN, P.O. BOX 114, ORANGEVALE, CA, 95662, US

(21) Appl. No.: 11/906,041

(22) Filed: Oct. 1, 2007

(51) Int. Cl. B62B 1/00

(52) U.S. Cl. 280/47.26

(57) ABSTRACT

The home, business and garden cart has features that are being user in todays market and thus eliminating a need to create new parts, the cart can be developed in a plant that uses similar types of parts.

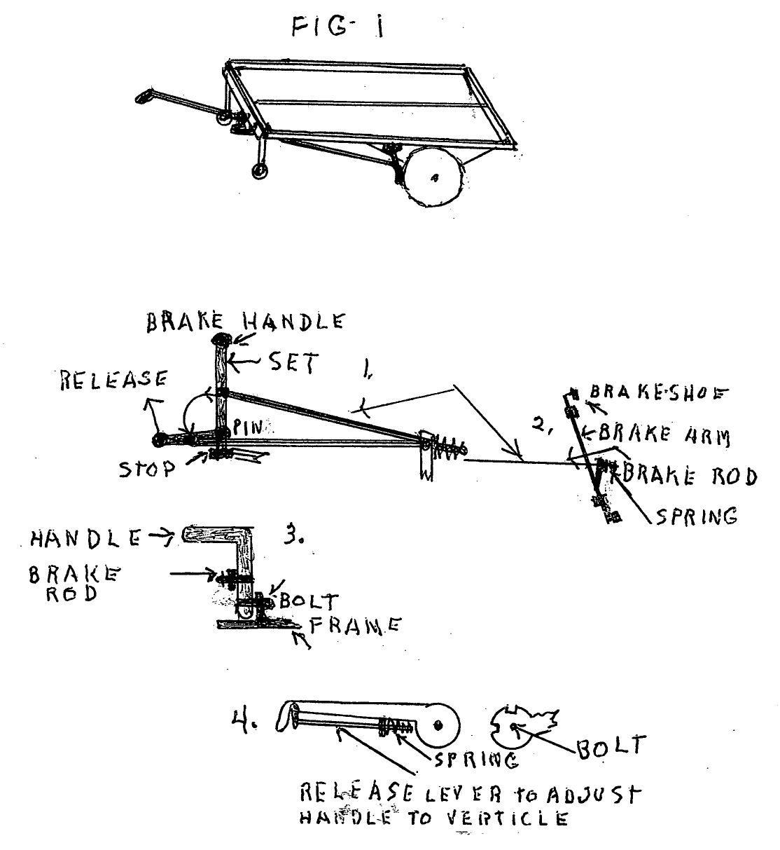

### BRIEF SUMMARY OF THE INVENTION

The home and garden cart has simple manufacturing features and can be used in many ways, in todays world it seems that every thing is complicated, the cart as I will call it, is simple to use and store and easy and safe even for a small child to move about, the added features make it a must for every home and business.

### BRIEF SUMMARY OF THE INVENTION

The gearless transmission is a system that has very few moving parts, and there fore requires less material to produce And in doing so, much energy such as coal or natural gas is saved, these are precious natural resources, also the Weight of the transmission, whether it is automatic or manual is reduced, and there for reduces need for heavy Front end suspension and also reduces wear on the front tires, a smaller motor is used and this also reduces the total Weight,

### BRIEF DESCRIPTION OF SEVERAL VIEWS OF THE DRAWINGS

1. Handle with ribbed end which allows the handle to be adjusted to desired height.
2. Cart body
3. Cart frame
4. Rollers that can be lowered down, to carry a heavy load.
5. Cart in tilted position for loading or unloading

### DETAILED DESCRIPTION OF THE INVENTION

The process of making the said cart is known in the field of manufacturing and each is prior art, however some of the features are of a new design usage, and all material is available in the market place.

1. What I claim as my invention is a two wheeled cart that can be used at home in the office or anywhere desired, it is light weight, can be used as a seat or to move most any item, in any materiel such as dirt, you need not shovel off the materiel, you simply lower the back of the cart to the ground and tip the cart over backwards and thus eliminating any extra work
